(19) United States
(12) Patent Application Publication
(10) Pub. No.: US 2011/0141409 A1
(43) Pub. Date: Jun. 16, 2011

(54) POLARIZER, DISPLAY DEVICE, AND PRODUCTION METHODS THEREOF

(75) Inventor: Takeyuki Ashida, Osaka-shi (JP)

(73) Assignee: SHARP KABUSHIKI KAISHA, Osaka-shi, Osaka (JP)

(21) Appl. No.: 13/002,061

(22) PCT Filed: Apr. 20, 2009
(86) PCT No.: PCT/JP2009/057855

§ 371 Date: Dec. 30, 2010

(30) Foreign Application Priority Data
Jul. 4, 2008 (JP) 2008-175614

(51) Int. Cl. G02F 1/1335; G02B 5/30

(52) U.S. Cl. 349/96; 359/488.01

(57) ABSTRACT

The present invention provides a polarizer and a display device, which can be easily produced and made thinner, and production methods thereof. The polarizer of the present invention relates to a polarizer including a polarizing film, wherein the polarizer further includes: a first adhesion layer which is formed of a cured adhesive and is laminated on one of main faces of the polarizing film, and a first protective layer which is laminated on a main face of the first adhesion layer on the side opposite to the polarizing film and has easy peelability at least in the main face thereof at the side of the first adhesion layer.

### TECHNICAL FIELD

The present invention relates to a polarizer and a display device, and production methods thereof. More specifically, the present invention relates to a polarizer and a display device, which are suitable for display devices for mobile terminals such as mobile phones, PDA (Personal Digital Assistant), PDA phones, handheld gaming devices, and tablet PC (Personal Computer), and production methods thereof.

### BACKGROUND ART

Flat panel displays which can be made thin have been widely used today as display device such as displays for TV, PC and mobile terminals. Examples of flat panel displays practically used today include liquid crystal display devices, organic electroluminescent display devices (hereinafter, also referred to as organic EL display), and plasma panel displays. Among the examples, liquid crystal displays and organic EL displays can easily achieve thinner models and low electric power consumption, and are thus widely utilized in mobile terminals such as mobile phones, PDAs, PDA phones, handheld gaming devices, tablet PCs, and the like.

A common liquid crystal display device normally includes a liquid crystal display panel having a pair of substrates and a liquid crystal layer interposed between the pair of substrates, a pair of polarizers each disposed on each side of the surfaces of the liquid crystal display panels, and a backlight unit having a light source.

An organic EL display is self-luminous and therefore does not require light sources such as backlight unit. In order to prevent reflection of external light, a circular polarizer formed of lamination of a retardation plate and a polarizer is normally provided on the surface of the organic EL display panel.

A polarizer generally includes, as a polarizing element, a polarizing film, which is basically a polyvinyl alcohol-based film (PVA film) having adsorbed an iodine complex or a dichroic pigment. Since production of polarizing films includes stretching, polarizing films tend to contract. Further, PVA films are very easily deformed especially under a humidified atmosphere due to the hydrophilic polymer used therein. Moreover, PVA films have low mechanical strength, and thus they tear easily. For this reason, a protective film (protective layer) made of TAC (triacetyl cellulose) and the like for protecting the polarizing film is attached to both sides of the main faces of the polarizing film. This arrangement reinforces the strength of the polarizer and also secures the credibility of the polarizing film as well.

There have been disclosed technical methods (for example, Patent Document 1) to reduce the thickness of such polarizers as mentioned earlier. According to the method, a resin layer surface of a transfer sheet on which an uncured ionizing radiation curable resin layer having adhesiveness is provided directly or via a releasing layer on one surface of a transparent substrate is attached to at least one surface of a polarizing film consisting of hydrophilic polymer, the resin layer is subjected to exposure treatment by the use of activated light rays and is cured, thereafter, the substrate is peeled as necessary and, thereby, an optical member having a protective layer on the surface of the polarization film is produced.

As a polarizer using a polarizing element other than a polarizing film, a polarizing element including an oriented dichroic molecular layer with both sides thereof provided with an adhesive layer has been disclosed (for example, Patent Document 2).

Meanwhile, in the field of mobile terminals, a display device has been developed in which a protective plate (cover substrate) is disposed on the display-side face of the display panel not only for protecting the display face of the display panel but for improving the design of the terminal as well.

Moreover, a display device having screen-input functions, which can detect positions touched by a contact body such as a pen or a finger on the display screen has been widely used. Touch panels, touch sensors and the like are generally employed as the means for detecting the positions touched by a contact body such as a pen and a finger. In the integral use of a touch panel and a display device, the touch panel is disposed on the display-side face of the display panel to achieve the touch panel function.
Patent Document 1: Japanese Kokai Publication No. 2006-163082
Patent Document 2: Japanese Kokai Publication No. Hei-09-197125

### DISCLOSURE OF THE INVENTION

As mentioned earlier, polarizing films are so vulnerable to environmental changes that they certainly need protective films. It is thus very difficult to deal with polarizing films without protective films. Meanwhile, in the case of display devices equipped with protective plates or touch panels, the protective layer of the polarizer and the function of protecting the display devices of the touch panel or the protective plate are overlapped, resulting in increase in module thickness.

In the case that the technique described in Patent Document 1 is employed to reduce the thickness of the module, until the ionizing radiation curable resin is cured, it is impossible to prevent dimensional changes of the polarizing film caused by thermal changes and/or humidity changes, especially warpage of the polarizing film due to contraction. More specifically, as the polarizing film generally uses PVA films that have been stretched to about four to five times the normal length, the contractile force of the polarizing film is considerably strong. The dimensional changes cause foaming in the ionizing radiation curable resin layer. Further, since an uncured ionizing radiation curable resin layer is soft, the contraction stress of the polarizing film is released to the ionizing radiation curable resin layer, which warps the polarizing film to the side of the ionizing radiation curable resin layer. Accordingly, in the case that a polarizer including an ionizing radiation curable resin layer is used for a display device equipped with a protective plate or a touch panel, warpage of the polarizing film needs to be very strictly controlled during the process of attaching the polarizer to the display panel. Further, in this case, an exposure device is indispensable after producing an original sheet of the polarizer.

The polarizer described in Patent Document 2 has inferior polarizing properties to the polarizer having a polarizing film, and is thus not practical. Moreover, since a pressure-sensitive adhesive material is used as the adhesive layer, it is difficult to prevent warpage or contraction of the polarizing film, similarly as in the case of using the ionizing radiation curable resin layer.

The present invention has been made in view of the above-mentioned state of the art. The present invention has an object to provide a polarizer and a display device, which can be easily produced and made thinner, and production methods thereof.

### MEANS FOR SOLVING THE PROBLEMS

The present inventors made various investigations on a polarizer and a display device which can be easily produced and can be made thinner, and production methods thereof, and thus they focus their attention on a protective layer for protecting the polarizing film of the polarizer. As a result, they found that use of a protective layer which is easily peelable from a polarizer and of an adhesion layer formed of a cured adhesive to attach the protective layer to a polarizing film makes it possible to handle the polarizer just in the same manner as in the case of using conventional polarizers during the production process. Further, by attaching the polarizer to the display panel and then peeling the protective layer, a protective plate or a touch panel can be attached to the polarizing film without the protective layer. Thus, the above-mentioned problems have been admirably solved, leading to completion of the present invention.

Namely, the present invention relates to a polarizer including a polarizing film, wherein the polarizer further includes: a first adhesion layer which is formed of a cured adhesive and is laminated on one of main faces of the polarizing film, and a first protective layer which is laminated on a main face of the first adhesion layer on the side opposite to the polarizing film and has easy peelability at least in the main face thereof at the side of the first adhesion layer.

This structure makes it possible to peel the first protective layer and then attach a protective plate or a touch panel to the polarizing film without interposing the first protective layer. Accordingly, since the protective plate, the touch panel or other members can be provided with the function to protect the polarizing film, the display device can be made thinner.

Since the first adhesion layer has been cured in the original sheet production, problems such as contraction and warpage of the polarizing film can be effectively prevented from occurring. Therefore, the polarizer of the present invention can be handled just in the same manner as in the case of conventional products.

Moreover, by attaching the polarizer of the present invention to the display panel and then peeling the first protective layer, the protective plate or the touch panel can be attached to the polarizing film without the first protective layer. In this manner, the polarizing film can be supported by the display panel during the process of attaching the protective plate or the touch panel. Therefore, problems such as contraction and warpage can be prevented from occurring in the process of attaching the protective plate or the touch panel.

The level of the easy peelability is preferably such that the first protective layer can be peeled from the first adhesion layer without causing any problems in the polarizing film.

The structure of the polarizer of the present invention is not particularly limited, and may include other structural elements as long as the structure of the present invention includes the foregoing structural elements as indispensable elements.

Following description will discuss the preferable embodiments of the polarizers of the present invention in more detail. Each of the embodiments mentioned below may be employed in combination.

The first protective layer may be formed by lamination of a layer (protective layer) not having easy peelability and having protective function and a layer (easily-peelable layer) having easy peelability, or may be formed of a single layer having easy peelability and protective function. In the case of the former, the first protective layer having desired protective function and easy peelability can be easily formed. In the case of the latter, formation of the first protective layer can be simplified.

Examples of especially preferable embodiments of the polarizer of the present invention include an embodiment in which the polarizing film contains a polyvinyl alcohol and an embodiment in which the polarizing film includes a stretched film. This structure can improve the optical characteristics of the polarizer.

The polarizer may further include: a second adhesion layer which is formed of a cured adhesive and is laminated on the other main face of the polarizing film, and a second protective layer which is laminated on a main face of the second adhesion layer on the side opposite to the polarizing film. This structure can further improve the credibility of the polarizing film of the present invention.

The materials or properties of the second protective layer are not particularly limited as long as the second protective layer protects the polarizing film and can be utilized for the display device. For example, the second protective layer may be an isotropic film having an optically isotropic property or may be a retardation film having a phase difference. Taking into consideration of production of a thinner display device and improvement of the display properties, the second protective layer preferably has a phase difference. Meanwhile, as the first protective layer is later peeled, the material and the properties thereof are not particularly limited as long as the foregoing functions can be executed during the production process.

The present invention also relates to a display device including a display panel, a polarizing film, and a substrate in this order, and the display device further includes a third adhesion layer which is formed of a cured adhesive and is laminated on a main face on the substrate side of the polarizing film and a third protective layer provided between the display panel and the polarizing film, and the substrate is attached with an attachment member to a main face of the third adhesion layer on the side opposite to the polarizing film.

This structure makes it possible to attach a protective plate or a touch panel to the polarizing film without interposing the protective layer. Accordingly, since the protective plate, the touch panel or other members can be provided with the function to protect the polarizing film, the display device can be made thinner.

The attaching member is not particularly limited as long as it can at least attach the substrate and the third adhesion layer. Examples of the attaching member include adhesives, pressure-sensitive adhesives, and double-sided tapes. The substrate is not particularly limited as long as it can be mounted on the display face of the display panel. Examples of the substrate include protective plates, and touch panels.

The structure of the display device of the present invention may or may not include other structural elements as long as the structure includes the foregoing structural elements as indispensable elements, and is not particularly limited.

The following description will discuss preferable embodiments of the display device. Each of the embodiments may be appropriately used in combination.

Examples of especially preferable embodiments of the display device of the present invention include an embodiment in which the polarizing film contains a polyvinyl alcohol and an embodiment in which the polarizing film includes a stretched film. This structure can improve the optical characteristics of the polarizer.

The materials or properties of the third protective layer are not particularly limited as long as the third protective layer protects the polarizing film and can be utilized for the display device. For example, the third protective layer may be an isotropic film having an optically isotropic property or may be a retardation film having a phase difference. Taking into consideration of production of a thinner display device and improvement of the display properties, the protective layer preferably has a phase difference.

The display panel may be a liquid crystal display panel or an organic electroluminescent display panel. This structure makes it possible to preferably utilize the display device of the present invention as mobile terminals.

The present invention also relates to a production method of a display device having a display panel, the production method including polarizer attaching process of attaching the polarizer of the present invention to the display panel, and peeling process of peeling the first protective layer after the polarizer attaching process.

This production method makes it possible to easily produce the display device of the present invention. Since the peeling process is performed after the polarizer attaching process, the polarizing film can be supported by the display panel in the process of attaching the protective plate or the touch panel to the display device. Therefore, warpage of the polarizing film can be prevented from occurring in the process of attaching the protective plate or the touch panel to the display device.

The production method of the display device according to the present invention is not particularly limited by other processes as long as it includes the aforementioned process.

### EFFECTS OF THE INVENTION

According to the polarizer of the present invention, it is possible to easily produce a polarizer which can reduce the thickness of the display device.

### BRIEF DESCRIPTION OF DRAWINGS

FIG. 1 is a schematic cross-sectional view showing a polarizer according to Embodiment 1 of the present invention.

FIG. 2 is a schematic cross-sectional view showing a modified example 1 of the polarizer according to Embodiment 1 of the present invention.

FIG. 3 is a schematic cross-sectional view showing a modified example 2 of the polarizer according to Embodiment 1 of the present invention.

FIG. 4 is a schematic cross-sectional view showing a modified example 3 of the polarizer according to Embodiment 1 of the present invention.

FIG. 5 is a schematic cross-sectional view showing a display device according to Embodiment 2 of the present invention.

FIG. 6 is a schematic cross-sectional view showing the display device according to Embodiment 2 of the present invention in the production process.

FIG. 7 is a schematic cross-sectional view showing a display device according to Embodiment 3 of the present invention.

FIG. 8 is a schematic cross-sectional view showing a display device according to Embodiment 4 of the present invention.

FIG. 9 is a schematic cross-sectional view showing a display device according to Embodiment 5 of the present invention.

### BEST MODE FOR CARRYING OUT THE INVENTION

The present invention is mentioned in more detail below with reference to Embodiments using drawings, but not limited to only these Embodiments.

### Embodiment 1

FIG. 1 is a schematic cross-sectional view showing a polarizer according to Embodiment 1 of the present invention.

A polarizer 10a of the present embodiment has a structure in which a protective layer 1a, an easily-peelable layer 2a, an adhesion layer 3a, a polarizing film 4, an adhesion layer 3b, a protective layer 1b, a pressure-sensitive adhesive layer 5, and a protective film 6 are laminated in this order. Namely, the easily-peelable layer 2a and the protective layer 1a, with the easily-peelable layer 2a attached to the adhesion layer 3a, are laminated through the adhesion layer 3a on one of the main faces of the polarizing film 4. The protective layer 1b is attached by the adhesion layer 3b to the other main face of the polarizing film 4. The pressure-sensitive adhesive layer 5 and the protective layer 6 are attached in this order to the main face of the protective layer 1b on the opposite side to the polarizing film 4. The protective layer 1a and the easily-peelable layer 2a can be peeled along the interface of the easily-peelable layer 2a and the adhesion layer 3a.

The polarizing film 4 is formed of a polyvinyl alcohol-based film (PVA film) which has adsorbed an iodine complex or a dichroic pigment. More specifically, the average saponification degree of the PVA film is 85 to 100% mol (preferably 98 to 100% mol), and the average polymerization degree is 1500 or more (preferably not less than 3500 to not more than 10000). The PVA film is stretched and then dipped for dyeing in an aqueous solution of an iodine complex or a dichroic pigment, or simultaneously stretched and dyed, or dyed in an iodine complex or a dichroic pigment and then stretched, so that the iodine complex or the dichroic pigment is adsorbed in the PVA film. Thereafter, the resulting product is treated with a boron compound for ruggedization so that the iodine complex or the dichroic pigment is fixed. The stretching ratio of the PVA film is preferably selected in the rage of 3 to 10 times (preferably 5 to 8 times), and the stretching temperature is preferably selected in the range of 40 to 130° C. In this manner, dyeing, i.e., adsorption of the polarizing material in the PVA film is performed by allowing the PVA film to contact to a liquid containing the polarizing material. In the case that the polarizing material to be used is an iodine complex, normally an iodine-potassium iodide solution is used. The iodine concentration is preferably 0.1 to 2 g/L, the potassium iodide concentration is preferably 10 to 50 g/L, and the weight ratio of iodine/potassium iodide is preferably 20 to 100. The dyeing time is practically around 30 to 500 seconds. The temperature of the dyeing bath is preferably 30 to 80° C. The aqueous solution for dyeing may contain a small amount of an organic solvent which is compatible with water in addition to an aqueous solvent. Examples of the applicable contacting means include given means such as dipping, application, and spraying. The dyed PVA film is then treated with a boron compound. Practical examples of the boron compound include boric acid and borax. The boron compound is used in the form of an aqueous solution or a solution in water/organic solvent mixture at a concentration of about 0.5 to 2 mol/L. It is preferably practical that a small amount of potassium iodide coexists in the solution. Immersion is preferably employed for the boron compound treatment, and of course application and spraying can be employed as well. The boron compound treatment is preferably performed at about 50 to 70° C. for a treatment period of about 5 to 20 minutes. PVA film-stretching operation may be performed, if necessary, during the boron compound treatment.

In the present embodiment, a polyvinyl alcohol-based film having average polymerization degree of 3800, saponification degree of 99.5%, and film thickness of 80 μm was immersed in an aqueous solution containing iodine (0.2 g/L) and potassium iodide (60 g/L) at 30° C. for 240 seconds, and then immersed in an aqueous solution containing boric acid (70 g/L) and potassium iodide (30 g/L). At the same time, the polyvinyl alcohol-based film was uniaxially stretched to six times the original length and was treated with boric acid for five minutes. Next, the polyvinyl alcohol film was dried at 30° C. for 24 hours, and thereby a polarizing film 4 was produced.

An acetylcellulose-based film is generally used as the protective layer 1a, but is not limited thereto. For example, a film made of thermoplastic saturated norbornene resin, polycarbonate (PC), polysulfone (PSu), polyarylate, polyethersulfone, polyethylene terephthalate (PET), polystyrene, PMMA, poly-α-methylsthyrene, or other materials may be used. Films made of a copolymer including the monomer units may be used as well. Since the protective layer 1a is peeled in a later process, the material for the film is preferably inexpensive.

In the present embodiment, a HC layer-including TAC film (KC8UX-H, produced by KONICA MINOLTA) in which surfactant-containing HC (acrylic UV curing resin) is applied on a TAC film as acetyl cellulose-based protective film was used. The HC layer functions as the easily-peelable layer 2a.

The protective layer 1b is preferably a film with high optical homogeneity because it has influence on the optical characteristics of the display device. In other words, the protective layer 1b preferably has uniform optical axis and uniform retardation, and also has optical isotropy. More specifically, the protective layer 1b is preferably a film with a tolerance of ±2° (more preferably ±1°) from the set angle of the optical axis in plane and a tolerance of ±10 nm (more preferably ±5 nm) from the set retardation. Meanwhile, the protective layer 1b may be a retardation layer which satisfies the optical demands of the display device. In other words, the protective layer 1b may have retardation. In the polarizer 10a, a film for optical compensation (optical compensation film) may be disposed on the polarizing film 4 on the side opposite to the protective layer 1a that is later to be peeled. Materials for the protective layer 1b may be the same materials as those for the protective layer 1a, and among which cellulose acetate (for example, TAC) and thermoplastic saturated norbornene-based resin are most generally used because they are technically established.

In the present embodiment, a thermoplastic saturated norbornene-based resin film (ARTON, produced by JSR, corona treated) having a film thickness of 70 μm was employed.

Since the polyvinyl alcohol-based film used for the polarizing film 4 and the cellulose acetate-based film used for the protective layer 1a and the protective layer 1b are both hydrophilic, a hydrophilic polyvinyl alcohol-based adhesive is generally used as materials (adhesive) for the adhesion layer 3a and the adhesion layer 3b. Other examples of the adhesive for the adhesion layer 3a and the adhesion layer 3b may include isocyanato-based adhesive, polyurethane-based adhesive, silicone-based adhesive, polyvinylalcohol-based adhesive, urethane-based adhesive, epoxy-based adhesive and acryl-based adhesive. As the adhesion layer 3a and the adhesion layer 3b attach one member to a different member, the adhesive for the adhesion layer 3a and the adhesive for the adhesion layer 3b may be different from one another depending on the functions thereof.

In the present embodiment, a polyvinyl-based adhesive (polyvinyl alcohol: 4 parts, melamine: 1 part, and water: 95 parts) was used as the adhesive for the adhesion layer 3a, and an isocyanato-based adhesive (isocyanato curing agent: 10 parts, polyvinyl alcohol: 3 parts, and water: 87 parts) was used as the adhesive for the adhesion layer 3b.

The easily-peelable layer 2a needs to have certain degree of adhesiveness with the adhesion layer 3a. Specifically, since the maximum radius of curvature of the polarizer 10a in the production process is approximately 50 mm, the easily-peelable layer 2a preferably has adhesiveness to such a degree that interlayer separation does not occur between the easily-peelable layer 2a and the adhesion layer 3a when the radius of curvature of the produced polarizer 10a is 50 mm. Meanwhile, the weaker the peel strength of the easily-peelable layer 2a, the better. In order to avoid damages to the polarizing film 4 upon peeling the easily-peelable layer 2a and the protective layer 1a, the easily-peelable layer 2a preferably has 180° peel strength of not more than 1 N/25 mm (peel rate: 300 mm/min) and more preferably not more than 0.5 N/25 mm (peel rate: 300 mm/min). The materials of the easily-peelable layer 2a are not particularly limited as long as the easily-peelable layer 2a is compatible with the adhesion layer 3a, and a layer formed of organic silicon compounds or fluorine compounds may be conveniently used. Specific examples of the layer include layers containing perfluorosilane, fluorocarbon, organic silicon compounds having fluoroalkyl group or fluorocycloalkyl group, fluorine-containing epoxy polymer, epoxy group-containing fluorosilicon polymer, fluorine-containing acrylic ester, fluorine-containing methacrylic acid ester, fluorine-containing fumaric acid diester, fluorine-containing unsaturated dibasic acid diester, organopolysiloxane having a silanol terminal, fluoroalkylacyl group-containing polysiloxane, copolymers of either perfluoroalkyl acrylate or perfluoroalkyl methacrylate and an alkoxysilane group-containing monomer, copolymers of an acrylate or methacrylate having a long chain fluoroalkyl group and a silicon-containing polymerizable unsaturated monomer, copolymers of an organic silazane having a long chain perfluoroalkyl group or an organic silazane having a long chain perfluoroalkyl ether group, compounds containing a fluorine-based surfactant, and the like.

In the present example, an HC layer of the HC layer-including TAC film (KC8UX-H, produced by KONICA MINOLTA) was utilized as the easily-peelable layer 2a.

Conventionally known products may be used as the materials (pressure-sensitive adhesive materials) of the pressure-sensitive adhesive layer 5 for attaching the polarizer 10a to the display panel and of the protective film 6 which protects the pressure-sensitive adhesive layer 5 until the process of attaching the polarizer 10a to the display panel.

The polarizer 10a according to the present embodiment makes it possible to peel the protective layer 1a and the easily-peelable layer 2a, and therefore any member such as protective plates and touch panels can be attached to the polarizing film 4 without interposing the protective layer 1a. Accordingly, it is possible to allow any member to have the function of protecting the polarizing film 4. As a result, the display device can be made thinner by the thickness of the protective layer 1a.

Since the adhesion layer 3a has been cured in the production of the original sheet of the polarizer 10a, the durability of the polarizing film 4 can be improved, which makes it possible to handle the polarizer 10a just in the same manner as in the case of using conventional polarizers. Accordingly, the polarizer 10a can be produced in existing polarizer-producing facilities.

Moreover, by attaching the polarizer 10a to the display panel and then peeling the easily-peelable layer 2a and the protective layer 1a, the protective plate or the touch panel can be attached to the polarizing film 4 without interposing the protective layer 1a. In this manner, the polarizing film 4 can be supported by the display panel during the process of attaching the protective plate or the touch panel. Therefore, warpage of the polarizing film 4 can be prevented from occurring in the process of attaching the protective plate or the touch panel.

Further, since the protective layer 1a having protective function and the easily-peelable layer 2a having easy peelability are separately provided, the protective layer 1a having desired protective function and the easily-peelable layer 2a having desired easy peelability can be formed without difficulty.

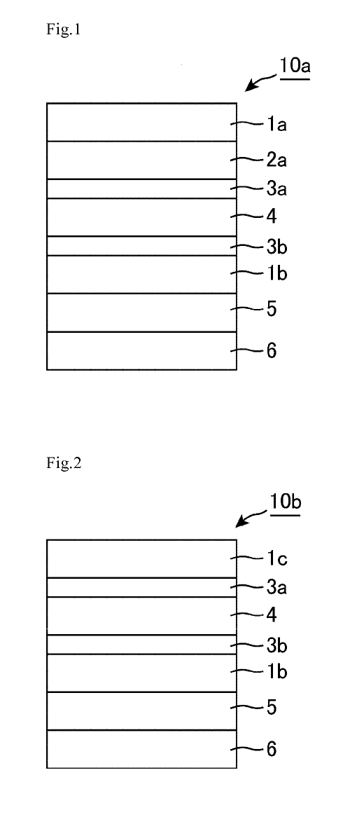

FIG. 2 is a schematic cross-sectional view showing a modified example 1 of the polarizer according to Embodiment 1 of the present invention.

The polarizer 10b of the modified example has the same structure as that of the polarizer 10a, except that a protective layer 1c is provided instead of the protective layer 1a and the easily-peelable layer 2a. The protective layer 1c is formed of the materials of the easily-peelable layer 2a or materials including the materials of the protective layer 1a and the materials of the easily-protective layer 2a. The protective layer 1c is a member having both of the protective function and the easy peelability. Accordingly, the protective layer 1c can be peeled along the interface of the protective layer 1c and the adhesion layer 3a in the polarizer 10b.

In the same manner as the polarizer 10a, the polarizer 10b can be handled just in the same manner as in the case of using conventional polarizers, and also makes it possible to reduce the thickness of the display device. Moreover, since the process of forming an easily-peelable layer on the protective layer 1c can be omitted, it is possible to simplify the production process.

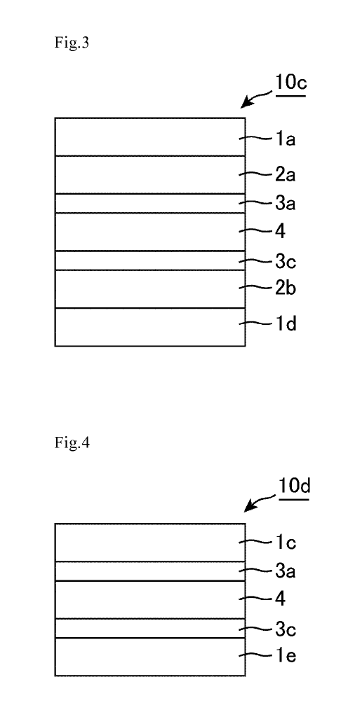

FIG. 3 is a schematic cross-sectional view showing a modified example 2 of the polarizer according to Embodiment 1 of the present invention.

A polarizer 10c according to the modified example has the same structure as that of the polarizer 10a, except that an adhesion layer 3c, an easily-peelable layer 2b and a protective layer 1d are provided instead of the adhesion layer 3b, the protective layer 1b, the pressure-sensitive adhesive layer 5, and the protective film 6. Namely, the polarizer 10c includes the polarizing film 4, the adhesion layer 3a which is formed of a cured adhesive and is laminated on one of the main faces of the polarizing film 4, the easily-peelable layer 2a which is laminated on the main face of the adhesion layer 3a on the side opposite to the polarizing film 4, the protective layer 1a which is laminated on the main face of the easily-peelable layer 2a on the side opposite to the adhesion layer 3a, the adhesion layer 3c which is formed of a cured adhesive and laminated on the other main face of the polarizing film 4, the easily-peelable layer 2b which is laminated on the main face of the adhesion layer 3c on the side opposite to the polarizing film 4, and the protective layer 1d laminated on the main face of the easily-peelable layer 2b on the side opposite to the adhesion layer 3c.

Accordingly, in the polarizer 10c, a pair of the easily-peelable layer 2a and the protective layer 1a, which are peelable, and a pair of the easily-peelable layer 2b and the protective layer 1d, which are peelable, are provided on the respective main faces of the polarizing film 4. Therefore, any member such as protective plates and touch panels can be attached to the polarizing film 4 without interposing the protective layer 1a, and at the same time, the display panel can be attached to the polarizing film 4 without interposing the protective layer 1d. As a result, a further thinner design of the display panel can be achieved.

Materials or properties of the adhesion layer 3c, the easily-peelable layer 2b, and the protective layer 1d may be selected based on the same viewpoints as those for the adhesion layer 3a, the easily peelable layer 2a, and the protective layer 1a.

FIG. 4 is a schematic cross-sectional view showing a modified example 3 of the polarizer according to Embodiment 1 of the present invention.

A polarizer 10d according to the modified example has the same structure as that of the polarizer 10c, except that the protective layer 1c having protective function and easy peelability is provided instead of the easily-peelable layer 2a and the protective layer 1a, and a protective layer 1e having protective function and easy peelability is provided instead of the easily-peelable layer 2b and the protective layer 1d. Namely, the polarizer 10d includes the polarizing film 4, the adhesion layer 3a which is formed of a cured adhesive and is laminated on one of the main faces of the polarizing film 4, the protective layer 1c which has easy peelability in the main face thereof at the side of the adhesion layer 3a and is laminated on the main face of the adhesion layer 3a on the side opposite to the polarizing film 4, the adhesion layer 3c which is formed of a cured adhesive and is laminated on the other main face of the polarizing film 4, and the protective layer 1e which is laminated on the main face of the adhesion layer 3c on the side opposite to the polarizing film 4 and has easy peelability in the main face thereof at the side of the adhesion layer 3a.

Accordingly, in the polarizer 10d, the easily-peelable protective layer 1c and the easily-peelable protective layer 1e are provided on the respective main faces of the polarizer 4. Therefore, any member such as protective plates and touch panels can be attached to the polarizing film 4 without interposing the protective layer 1c, and at the same time, the display panel can be attached to the polarizing film 4 without interposing the protective layer 1e. As a result, a further thinner design of the display panel can be achieved.

The materials or properties of the protective layer 1e may be selected based on the same viewpoints as those for the protective layer 1c.

The polarizer of the present embodiment may have an embodiment formed by a combination of the modified example 2 and the modified example 3. For example, in the polarizer 10c, the easily-peelable layer 2b and the protective layer 1d may be replaced with the protective layer 1e.

### Embodiment 2

FIG. 5 is a schematic cross-sectional view showing a display device according to Embodiment 2 of the present invention.

A display device 100a of the present embodiment has a structure in which a touch panel 31, an attaching member 41, the adhesion layer 3a, the polarizing film 4, the adhesion layer 3b, the protective layer 1b, the pressure-sensitive adhesive layer 5, a liquid crystal display panel 21, and a rear polarizer 11 are laminated.

The following description will discuss the method of producing a display device 100a according to the present embodiment. First, the protective film 6 is peeled from the polarizer 10a of the Embodiment 1. The polarizer 10a is attached by the pressure-sensitive adhesive layer 5 to the liquid display panel 21 on the side to which the touch panel 31 is to be attached. The rear polarizer 11 is attached to the backside of the liquid crystal display panel 21 via a pressure-sensitive adhesive layer (not shown) which is similar to the pressure-sensitive adhesive layer 5.

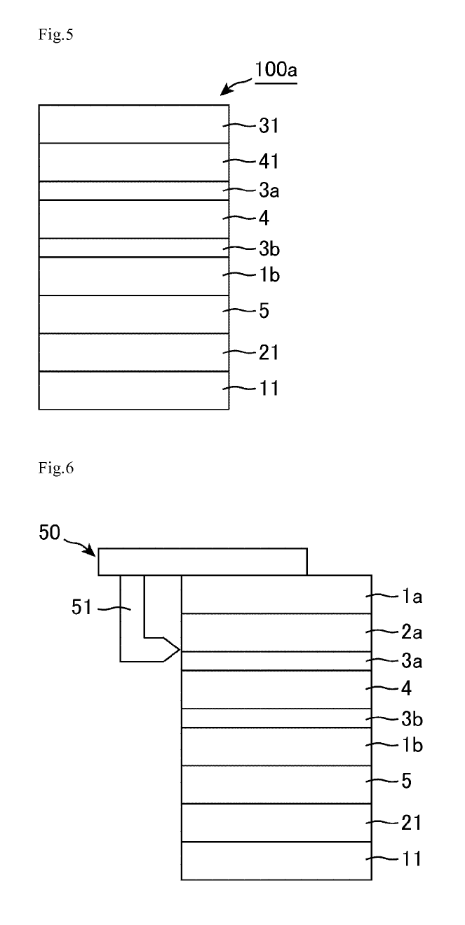

Next, a tape is attached to the surface of the protective layer 1a of the polarizer 10a, and then the tape is pulled so as to peel the protective layer 1a and the easily-peelable layer 2a in a manner similar to the peeling of the protective film 6. Alternatively, as shown in FIG. 6, the protective layer 1a and the easily-peelable layer 2a are peeled after forming a trigger for peeling with a blade 51 of a jig 50 between the easily-peelable layer 2a and the adhesion layer 3a. In this case, the cured adhesion layer 3a remains on the polarizer film 4, which enables preventing the credibility of the polarizer film 4 from decreasing. Also, since the polarizing film 4 is supported by the liquid crystal display panel 21, warping or contraction of the polarizing film 4 can be prevented from occurring. Accordingly, the present embodiment does not need strict control of the temperatures, humidity, and the like during the process of attaching the touch panel 31 to the liquid crystal display panel 21. Moreover, since the cured adhesion layer 3a remains on the polarizing film 4, it is possible to prevent undesired chemical reactions between the attaching member 41 and the polarizing film 4 which may deteriorate the polarizing properties of the polarizing film 10a. Meanwhile, since the adhesion layer 3a has no adhesion, the easily-peelable layer 2a and the adhesion layer 3a cannot be again attached to the adhesion layer 3a after peeling the easily-peelable layer 2a and the adhesion layer 3a.

Then, the touch panel 31 is attached to the exposed polarizing film 4 (with the adhesion layer 3a remaining thereon) by the attaching member 41.

Accordingly, the display device 100a makes it possible to reduce the thickness of the module by the amount corresponding to the total thickness of the protective layer 1a and the easily-peelable layer 2a. Moreover, the touch panel 31 and the polarizer 10a are fully attached with one another by the attaching member 41 without the protective layer 1a, and thus the touch panel 31 may also be used as an protective member of the polarizing film 4.

The attaching member 41 is not particularly limited, and examples thereof include adhesives, pressure-sensitive adhesives, and double-sided tapes. Examples of the adhesives include UV curing resins and thermosetting resins. The adhesive for the adhesion layer 3a and the adhesion layer 3b, which are explained in Embodiment 1, may be used depending on the materials of the touch panel 31. As mentioned earlier, the present embodiment can be produced without an exposure device by the same production lines as the conventional lines.

In the present embodiment, the polarizer 10b, the polarizer 10c, or the polarizer 10d may be used instead of the polarizer 10a.

A single or several sheet(s) of retardation film may be interposed between the liquid crystal display panel 21 and the polarizer 10a and/or between the liquid crystal display panel 21 and the rear polarizer 11 in a manner allowing the optical properties of the liquid crystal display panel 21 to match the desired optical properties.

### Embodiment 3

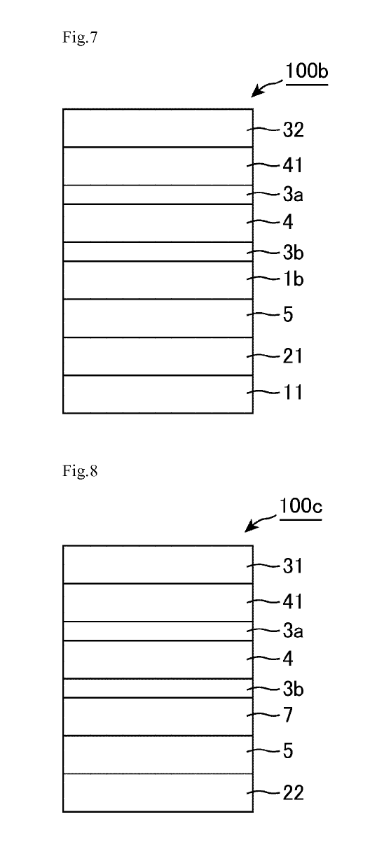

FIG. 7 is a schematic cross-sectional view showing a display device according to Embodiment 3 of the present invention.

A display device 100b of the modified example has the same structure as that of the display device 100a according to the Embodiment 2, except that a protective plate 32 is provided instead of the touch panel 31. The display device 100b can have the same effect as that of the display device 100a according to the Embodiment 2. Meanwhile, materials and thickness of the protective plate 32 are not particularly limited as long as the protective plate 32 has high transparency and protective functions.

### Embodiment 4

FIG. 8 is a schematic cross-sectional view showing a display device according to Embodiment 4 of the present invention.

A display device 100c of the present embodiment has the same structure as that of the display device 100a according to Embodiment 2, except that an organic EL panel 22 is provided instead of the liquid crystal display panel 21, and a quarter-wave plate 7 is provided instead of the protective layer 1b, and the rear polarizer 11 is not provided. The display device 100c as well can have the same effect as that of the display device 100a according to Embodiment 2. Meanwhile, the optical axis (fast axis or slow axis) of the quarter-wave plate 7 intersects with the optical axis (transmission axis or absorption axis) of the polarizing film 4 at a crossing angle of 45°. The polarizing film 4 and the quarter-wave plate 7 function as circular polarizers.

### Embodiment 5

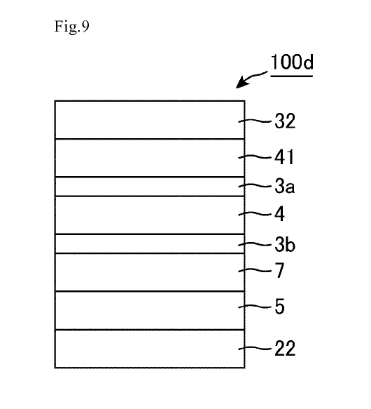

FIG. 9 is a schematic cross-sectional view showing a display device according to Embodiment 5 of the present invention.

A display device 100d of the present embodiment has the same structure as that of the display device 100c according to Embodiment 4, except that the protective plate 32 is provided instead of the touch panel 31. The display device 100d can have the same effect as that of the display device 100a according to Embodiment 2. Meanwhile, materials and thickness of the protective plate 32 are not particularly limited as long as the protective plate 32 has high transparency and protective functions.

### Comparative Example 1

A polarizer according to this Comparative Example has the same structure as that of the polarizer according to Embodiment 1, except that the adhesion layer 3b and the protective layer 1a are provided instead of the adhesion layer 3a, the protective layer 1a, and the easily-peelable layer 2a. Namely, the polarizer of the present comparative example is a normal polarizer in which a protective layer, an adhesion layer, a polarizing film, an adhesion layer, a protective layer, a pressure-sensitive adhesive layer and a protective film are laminated in this order.

### Comparative Example 2

A display device according to this Comparative Example has the same structure as that of the display device according to Embodiment 3, except that the polarizer of Comparative Example 1 is provided instead of the polarizer 10a. Namely the display device of the present comparative example is a normal liquid crystal display device equipped with a protective plate in which a protective plate, an attaching member, a protective layer, an adhesion layer, a polarizing film, an adhesion layer, a protective layer, a pressure-sensitive adhesive layer, a liquid crystal display panel, and a rear polarizer are laminated.

### “Credibility Test”

Credibility tests were performed on the polarizers of Embodiment 1 and Comparative Example 1, and the display devices of Embodiment 3 and Comparative Example 2. The results will be discussed below. As the credibility tests, high-temperature environment test (keeping at 85° C. under dry conditions for 1000 hours), high humidity environment test (keeping at 60° C. and 90% humidity for 1000 hours), heat shock test (500 cycles of keeping at 85° C. under dry conditions for 0.5 hours and then keeping at −40° C. under dry conditions for 0.5 hours), and low-temperature environment test (keeping at −40° C. for 1000 hours) were performed. The results showed that no appearance defects were found in all the polarizers of Embodiment 1 and Comparative Example 1 in each of the tests. Moreover, as shown in Table 1, comparison of changes in the polarization degree as optical properties between before and after the high temperature environment test and the high humidity environment test showed that the polarizer of Embodiment 1 had the similar performance as that of the normal polarizer with no easily-peelable layer (the polarizer of Comparative Example 1).

TABLE 1

| | Embodiment 1 | Comparative Example 1 |
|---|---|---|
| High temperature | 0.01% decrease | 0.012% decrease |
| environment test | | |
| High humidity | 0.006% decrease | 0.01% decrease |
| environment test | | |

Also, no appearance defects were found in all the polarizers of Embodiment 3 and Comparative Example 2 in each of the tests. Moreover, as shown in Table 2, comparison of changes in the polarization degree as optical properties between before and after the high temperature environment test and the high humidity environment test showed that the polarizer of Embodiment 3 had the same performance as that of the normal polarizer with no easily-peelable layer (the polarizer of Comparative Example 2).

TABLE 2

| | Embodiment 3 | Comparative Example 2 |
|---|---|---|
| High temperature | 0.019% decrease | 0.02% decrease |
| environment test | | |
| High humidity | 0.009% decrease | 0.007% decrease |
| environment test | | |

The present application claims priority under the Paris Convention and the domestic law in the country to be entered into national phase on Patent Application No. 2008-175614 filed in Japan on Jul. 4, 2008, the entire contents of which are hereby incorporated by reference.

### EXPLANATION OF NUMERALS AND SYMBOLS

1a, 1b, 1c, 1d, 1e: protective layer
2a, 2b: easily-peelable layer
3a, 3b, 3c: adhesion layer
4: polarizing film
5: pressure-sensitive adhesive layer
6: protective film
7: quarter-wave plate
10a, 10b, 10c, 10d: polarizer
11: rear polarizer
21: liquid crystal display panel
22: organic EL panel
31: touch panel
32: protective plate
41: attaching member
50: jig
51: blade
100a, 100b, 100c, 100d: display device

1. A polarizer comprising a polarizing film,
wherein the polarizer further comprises:
a first adhesion layer which is formed of a cured adhesive and is laminated on one of main faces of the polarizing film, and
a first protective layer which is laminated on a main face of the first adhesion layer on the side opposite to the polarizing film and has easy peelability at least in the main face thereof at the side of the first adhesion layer.

2. The polarizer according to claim 1,
wherein the first protective layer is formed by lamination of a layer not having easy peelability and having protective function and a layer having easy peelability.

3. The polarizer according to claim 1,
wherein the first protective layer comprises a single layer having easy peelability and protective function.

4. The polarizer according to claim 1,
wherein the polarizing film contains a polyvinyl alcohol.

5. The polarizer according to claim 1,
wherein the polarizing film comprises a stretched film.

6. The polarizer according to claim 1,
wherein the polarizer further comprises:
a second adhesion layer which is formed of a cured adhesive and is laminated on the other main face of the polarizing film, and
a second protective layer which is laminated on a main face of the second adhesion layer on the side opposite to the polarizing film.

7. The polarizer according to claim 6,
wherein the second protective layer has a phase difference.

8. A display device comprising a display panel, a polarizing film, and a substrate in this order,
wherein the display device further comprises a third adhesion layer which is formed of a cured adhesive and is laminated on a main face on the substrate side of the polarizing film and a third protective layer provided between the display panel and the polarizing film, and
the substrate is attached with an attachment member to a main face of the third adhesion layer on the side opposite to the polarizing film.

9. The display device according to claim 8,
wherein the polarizing film contains a polyvinyl alcohol.

10. The display device according to claim 8,
wherein the polarizing film comprises a stretched film.

11. The display device according to claim 8,
wherein the third protective layer has a phase difference.

12. The display device according to claim 8,
wherein the display panel is a liquid crystal display panel or an organic electroluminescent display panel.

13. A production method of a display device having a display panel,
which comprises polarizer attaching process of attaching the polarizer of claim 1 to the display panel, and
peeling process of peeling the first protective layer after the polarizer attaching process.
